(19) United States
(12) Patent Application Publication
(10) Pub. No.: US 2020/0409762 A1
(43) Pub. Date: Dec. 31, 2020

(54) METHOD AND APPARATUS FOR SERVICING AN INTERRUPT

(71) Applicant: Advanced Micro Devices, Inc., Santa Clara, CA (US)

(72) Inventors: Alexander J. Branover, Boxborough, MA (US); Elliot H. Mednick, Boxborough, MA (US); Benjamin Tsien, Santa Clara, CA (US)

(73) Assignee: Advanced Micro Devices, Inc., Santa Clara, CA (US)

(21) Appl. No.: 16/454,013

(22) Filed: Jun. 26, 2019

(51) Int. Cl. G06F 9/50; G06F 9/4401

(52) U.S. Cl. CPC G06F 9/5027; G06F 2209/5022; G06F 9/4418

(57) ABSTRACT

A method and apparatus for servicing a task in a computer system includes receiving the task and if the task is serviceable without waking the fabric, servicing the task by a first service stage entity. If the task is not serviceable by the first service stage entity, the task is serviced by a first processing unit without waking a second processing unit. If the task is not serviceable by the first processing unit, the task is serviced by the second processing unit.

### BACKGROUND

In a system on chip (SOC) environment, an interrupt may occur for a number of reasons. In order to conventionally service an interrupt, the entire central processing unit (CPU) complex is awoken. This incurs increased power requirements, as well as processing delays.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a schematic diagram of task service hierarchy, in accordance with an example; and

FIG. 3 is a flow diagram of an example method of servicing task, according to an example.

### DETAILED DESCRIPTION

Although the method and apparatus will be expanded upon in further detail below, briefly a method and apparatus are described herein to maximize the performance or power savings of the system on chip (SOC) by gradual engaging of the interrupt service stages, only when necessary. As a result, the central processing unit (CPU) complex of the SOC and other significant circuitry remains undisturbed by interrupt tasks that may be handled by an intermediate interrupt service entity.

Described herein are example stages for task service. Other SOCs may involve more stages in a finer granular way. Also other embodiments may introduce macro-IPs (interrupts) having a number of built in stages for interrupts/activity service. Incoming input/output (I/O) events, sensor notifications or system level events are handled by the first (or initial) stage having its own local memory. Once the first stage infers that this specific task or interrupt service requires access to the main memory or needs an x86 state to run, the second stage (e.g., mini processor or mini controller) is invoked. If the second stage infers that its utilization is too high or it has insufficient capacity for the task, the final stage (e.g., the CPU complex) is engaged. Independent metrics/criteria can serve for each of these transitions. Further, software, drivers and operating systems may be unaware of any of these transitions making it very efficient in that no additional resources need to be utilized in the operating system or to execute software to perform the task servicing.

For example, active-state residency may be used as a metric. If residency in the active state is greater than a threshold amount of time, this implies high utilization. Another example metric is core utilization over a moving interval (i.e., total active time of the core's use over a configurable interval). The rate of instruction retirement is an additional metric, For example, if the rate of the instruction retirement drops below a threshold, then more performance capacity is required and a transition to a more powerful processor is effected.

Also, past history of active-state residency or instruction retirement rates may be used. For example, long active state residency or good instruction retirement rates may be predicted in the final stage without waiting for the second stage to meet any metric in the current active state. Successive stages require longer power up latency, meaning that a final stage CPU complex power up latency is higher than a second stage mini processor powerup, for example. For cases where prior history justifies powering up the next stage as quickly as possible, the prior stage can execute in parallel to the next stage power up, and then perform a context transfer to the next stage as it comes online.

Different system configurations or different embodiments may engage different numbers of stages. The example described herein includes two sets of wake up timers—a timer running in the Always On (AON) part of the SOC, and a timer running in the fabric. Other embodiments may have just one type of timer. In the example described herein, the AON timer wake up events are handled by the first stage. The fabric/Local Advanced Programmable Interrupt Controller (LAPIC) timers are handled by the mini-processor.

A method for servicing a task in a computer system includes receiving the task and if the task is serviceable without waking the fabric, servicing the task by a first service stage entity. If the task is not serviceable by the first service stage entity, the task is serviced by a first processing unit without waking a second processing unit. If the task is not serviceable by the first processing unit, the task is serviced by the second processing unit.

An apparatus for servicing a task in a computer system includes a first stage circuitry that services a received task if the task is serviceable without waking a fabric. A first processing unit is communicatively coupled with the first stage circuitry. A second processing unit is communicatively coupled with the first processing unit. The first processing unit services the task without waking the second processing unit if the task is not serviceable by the first service stage circuitry, and the second processing unit services the task if the task is not serviceable by the first processing unit.

A non-transitory computer-readable medium for servicing a task in a computer system includes instructions recorded thereon, that when executed by the processor, cause the processor to perform operations. The operations include receiving the task and if the task is serviceable without waking a fabric, servicing the task by a first service stage circuitry, If the task is not serviceable by the first service stage circuitry, the task is serviced by a first processing unit without waking a second processing unit. If the task is not serviceable by the first processing unit, the task is serviced by the second processing unit.

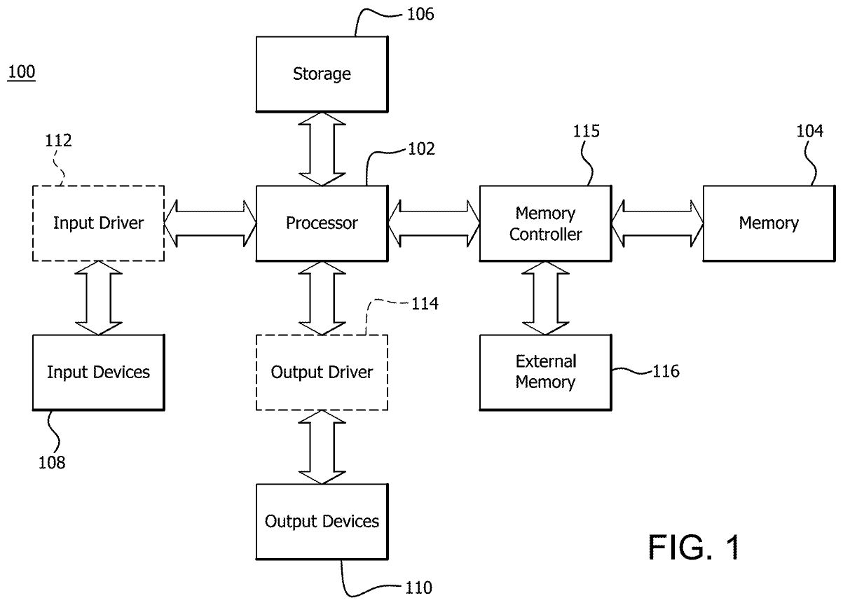

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. Additionally, the device 100 includes a memory controller 115 that communicates with the processor 102 and the memory 104, and also can communicate with an external memory 116. The external memory may also be a storage class memory (SCM) or next-level memory. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

The external memory 116 may be similar to the memory 104, and may reside in the form of off-chip memory. Additionally, the external memory may be memory resident in a server where the memory controller 115 communicates over a network interface to access the memory 116.

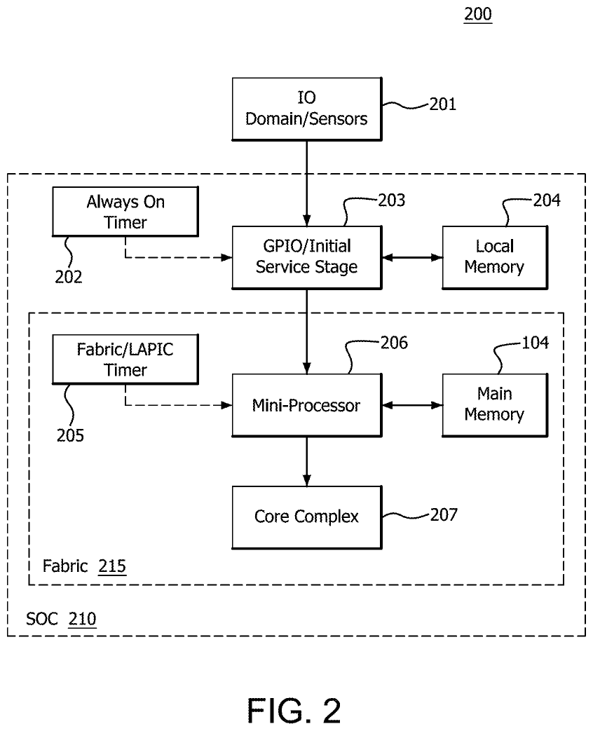

FIG. 2 is a schematic diagram of a system 200 including an interrupt service hierarchy, in accordance with an example. As shown in FIG. 2, Input/Output (TO) domain/sensors 201 are communicatively coupled with a General Purpose Input Output (GPIO)/initial service stage circuitry 203, which is operatively coupled with a first processing unit such as a mini-processor 206 (i.e., a processor with limited computing power compared to a central processing unit (CPU) requiring less power consumption and resources), which is operatively coupled with a second processing unit, such as the core complex 207 (including the CPU). An always on timer 202 is connected to the GPIO/initial service stage circuitry 203, which includes a local memory 204. A fabric/LAPIC timer 205 is connected to the mini-processor 206, which also has access to the main memory 104. All of the components in FIG. 2 except for the IO domain/sensors 201 are part of the SOC 210. The fabric/LAPIC timer 205, mini-processor 206, main memory 104, and core complex 207 are considered the fabric 215.

Accordingly, in FIG. 2, an hierarchical interrupt service by gradual engaging task service capable entity stages is realized. Each stage requires additional resources, such as additional power consumption. Therefore, less power and resources may be expended by servicing tasks at earlier stages if the tasks can be serviced at those stages.

Tasks are evaluated at each stage to determine whether or not the task can be serviced at that stage. If the task can be serviced at that stage, it is serviced at that stage, and additional resources are not activated, or awoken, to service the task. Therefore, the use of resources is efficiently managed.

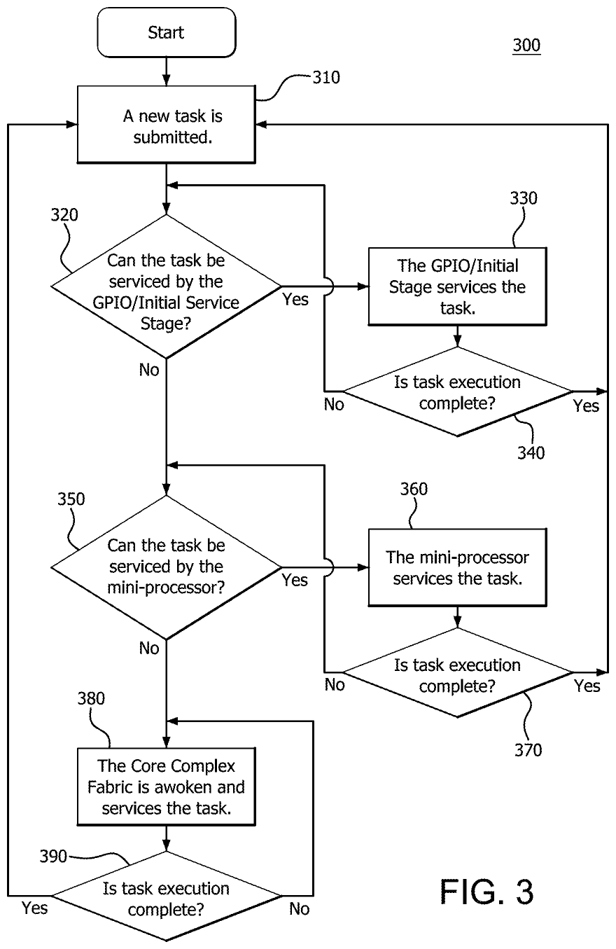

FIG. 3 is a flow diagram of an example method 300 of servicing a task, according to an example. In step 310 a new task is submitted. For example, referring back to FIG. 2, the task may be submitted from the IO domain sensors 201, the always on timer 202 or the fabric/LAPIC timer 205. In step 320, it is determined if the task can be serviced by the GPIO/initial service stage 203.

The GPIO/initial service stage 203 may utilize metrics to determine whether or not the task can be serviced by the GPIO/initial service stage 203 without invoking a higher level resource. The metrics utilized may be internal metrics to the GPIO/initial service stage 203 and are also used to determine whether the next stage should be utilized for task servicing/execution.

For example, if the task does not require x86 resources, then the GPIO/initial service stage 203 can service the task without waking the fabric (step 330). If task execution is complete (step 340), then the method proceeds to step 310, otherwise the method proceeds to step 320.

In this manner, by having the task be serviced by the GPIO/initial service stage 203, the fabric 215, which requires additional power and resources, does not need to be awakened. If the task cannot be serviced by the GPIO/initial service stage 203 (step 320), then the mini-processor 206 is awakened.

Again, in step 320, the GPIO/initial service stage 203, using internal metrics to the GPIO/initial service stage 203 determines whether the next stage should be utilized for task servicing/execution. In this case, the task is passed to the next stage, which in this case would be the mini-processor 206.

It is determined then, by the mini-processor 206, whether or not the task passed to it from the GPIO/initial service stage 203 can be serviced by the mini-processor 206 (step 350). Similar to the previous stage, the mini-processor 206 may utilize metrics to determine whether or not the task can be serviced by the mini-processor 206 without invoking a higher level resource. The metrics utilized may be internal metrics to the mini-processor 206 and are also used to determine whether the next stage should be utilized for task servicing/execution.

For example, if the task requires x86 resources but the task is not complicated, the mini-processor 206 services the task (step 360), and the core complex is not awakened. If task execution is complete (step 370), then the method proceeds to step 310, otherwise the method proceeds to step 350.

In this manner, by having the task be serviced by the mini-processor 206, the core complex 207, which requires additional power and resources than the mini-processor 206, does not need to be awakened. If the task cannot be serviced by the mini-processor 206 (step 350), then the core complex 207 is awakened.

Again, in step 350, the mini-processor 206, using internal metrics to the mini-processor 206 determines whether the next stage should be utilized for task servicing/execution. In the case where the mini-processor 206 determines that it cannot service the task, the task is passed to the next stage, which in this case is the core complex 207.

For example, if the task is complicated and/or longer, the mini-processor 206 may not be able to service the interrupt and the CPU core complex 207 is required. Accordingly, the core complex 207 is awakened and services the task (step 380). If task execution is complete (step 390), then the method proceeds to step 310, otherwise the method proceeds to step 380.

To transfer execution from one stage to the next, interrupts may be routed to a targeted stage, then execution transferred as successive stages are powered up, which may occur in parallel or on demand. Execution can be transparently passed between different cores. In one example, a second stage core may take an interrupt originally targeted for a final stage core followed by a decision (e.g., hardware decision) to power up the CPU complex of the original final stage core to take over. After power up, the second stage core sends a hardware inter-processor interrupt (IPI) to the originally intended final stage core, saves the current state to memory (e.g., DRAM), and the interrupt handler on the final stage core restores that state from memory to continue execution.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). For example, the methods described above may be implemented in the processor 102 or on any other processor in the computer system 100.

What is claimed is:

1. A method for servicing a task in a computer system, comprising:
receiving the task and responsive to the task being serviceable without waking a fabric, servicing the task by a first service stage circuitry;
responsive to the task not being serviceable by the first service stage circuitry, servicing the task by a first processing unit without waking a second processing unit; and
responsive to the task not being serviceable by the mini-processor, servicing the task by the second processing unit.

2. The method of claim 1, wherein the task is submitted for servicing by any one of an input/output (IO) domain/sensors, an always on timer, or a fabric/Local Advanced Programmable Interrupt Controller (LAPIC) timer.

3. The method of claim 2, wherein the JO domain/sensors or the always on timer submit the task to the first service stage circuitry for servicing.

4. The method of claim 3, wherein the first service stage circuitry is a General Purpose Input Output (GPIO)/initial service stage circuitry.

5. The method of claim 3, wherein the task does not require a first type of resources and the first service stage entity services the task.

6. The method of claim 5, wherein the first type of resources are x86 resources.

7. The method of claim 3, wherein the task requires a first type of resources or requires access to main memory, and is not serviceable by the first service stage entity, and an interrupt is routed to the first processing unit.

8. The method of claim 7, wherein the first type of resources are x86 resources.

9. The method of claim 7, wherein the first processing unit determines whether its utilization is below a threshold and includes the capacity for servicing the task, the first processing unit services the task.

10. The method of claim 7, wherein responsive to the first processing unit utilization being above a threshold or the first processing unit does not have the capacity to service the task, the second processing unit is awoken to service the task.

11. The method of claim 2, wherein the fabric/LAPIC timer submits a task to the first processing unit.

12. The method of claim 11, wherein the first processing unit determines whether its utilization is below a threshold and includes the capacity for servicing the task, the first processing unit services the task.

13. The method of claim 11, wherein responsive to the first processing unit utilization being above a threshold or the first processing unit does not have the capacity to service the task, the second processing unit is awoken to service the task.

14. The method of claim 1, wherein the first processing unit is a mini-processor having limited computing power and the second processing unit is a central processing unit (CPU) core complex.

15. An apparatus for servicing a task in a computer system, comprising:
a first stage circuitry that services a received task responsive to the task being serviceable without waking a fabric;
a first processing unit communicatively coupled with the first stage circuitry; and
a second processing unit communicatively coupled with the first processing unit,
wherein the first processing unit services the task without waking the second processing unit responsive to the task not being serviceable by the first service stage circuitry, and
wherein the second processing unit services the task responsive to the task not being serviceable by the first processing unit.

16. The apparatus of claim 15, further comprising:
an input/output (TO) domain/sensors communicatively coupled to the first stage circuitry;
an always on timer communicatively coupled to the first stage circuitry; and
a fabric/Local Advanced Programmable Interrupt Controller (LAPIC) timer communicatively coupled to the first processing unit.

17. The apparatus of claim 16, wherein the IO domain/sensor or the always on timer submit the task to the first service stage circuitry.

18. The apparatus of claim 17, wherein the first service stage circuitry is a General Purpose Input Output (GPIO)/initial service stage circuitry.

19. The apparatus of claim 17, wherein the task does not require a first type of resources and the first service stage entity services the task.

20. The apparatus of claim 19, wherein the first type of resources are x86 resources.

21. The apparatus of claim 17, wherein the task requires a first type of resources or requires access to main memory, and is not serviceable by the first service stage entity, and an interrupt is routed to the first processing unit.

22. The apparatus of claim 21, wherein the first type of resources are x86 resources.

23. The apparatus of claim 21, wherein the first processing unit determines whether its utilization is below a threshold and includes the capacity for servicing the task, the first processing unit services the task.

24. The apparatus of claim 21, wherein responsive to the first processing unit utilization being above a threshold or the first processing unit does not have the capacity to service the task, the second processing unit is awoken to service the task.

25. The apparatus of claim 16, wherein the fabric/LAPIC timer submits a task to the first processing unit.

26. The apparatus of claim 25, wherein the first processing unit determines whether its utilization is below a threshold and includes the capacity for servicing the task, the first processing unit services the task.

27. The apparatus of claim 25, wherein responsive to the first processing unit utilization being above a threshold or the first processing unit does not have the capacity to service the task, the second processing unit is awoken to service the task.

28. The apparatus of claim 15, wherein the first processing unit is a mini-processor having limited computing power and the second processing unit is a central processing unit (CPU) core complex.

29. A non-transitory computer-readable medium for servicing a task in a computer system, the non-transitory computer-readable medium having instructions recorded thereon, that when executed by the processor, cause the processor to perform operations including:
receiving the task and responsive to the task being serviceable without waking a fabric, servicing the task by a first service stage circuitry;
responsive to the task not being serviceable by the first service stage circuitry, servicing the task by a first processing unit without waking a second processing unit; and
responsive to the task not being serviceable by the first processing unit, servicing the task by the second processing unit.

30. The non-transitory computer-readable medium of claim 29, wherein the task is submitted for servicing by any one of an input/output (TO) domain/sensors, an always on timer, or a fabric/Local Advanced Programmable Interrupt Controller (LAPIC) timer.

31. The non-transitory computer-readable medium of claim 30, wherein the IO domain/sensors or the always on timer submit the task to the first service stage circuitry for servicing.

32. The non-transitory computer-readable medium of claim 31, wherein the first service stage circuitry is a General Purpose Input Output (GPIO)/initial service stage circuitry.

33. The non-transitory computer-readable medium of claim 31, wherein the task does not require a first type of resources and the initial service stage entity services the task.

34. The non-transitory computer-readable medium of claim 33, wherein the first type of resources are x86 resources.

35. The non-transitory computer-readable medium of claim 31, wherein the task requires a first type of resources or requires access to main memory, and is not serviceable by the first service stage entity, and an interrupt is routed to the first processing unit.

36. The non-transitory computer-readable medium of claim 35, wherein the first type of resources are x86 resources.

37. The non-transitory computer-readable medium of claim 35, wherein the first processing unit determines whether its utilization is below a threshold and includes the capacity for servicing the task, the first processing unit services the task.

38. The non-transitory computer-readable medium of claim 35, wherein responsive to the first processing unit utilization being above a threshold or the first processing unit does not have the capacity to service the task, the second processing unit is awoken to service the task.

39. The non-transitory computer-readable medium of claim 30, wherein the fabric/LAPIC timer submits a task to the first processing unit.

40. The non-transitory computer-readable medium of claim 39, wherein the first processing unit determines whether its utilization is below a threshold and includes the capacity for servicing the task, the first processing unit services the task.

41. The non-transitory computer-readable medium of claim 39, wherein responsive to the first processing unit utilization being above a threshold or the first processing unit does not have the capacity to service the task, the second processing unit is awoken to service the task.

42. The non-transitory computer-readable medium of claim 39, wherein the first processing unit is a mini-processor having limited computing power and the second processing unit is a central processing unit (CPU) core complex.
